(19) United States
(12) Patent Application Publication
(10) Pub. No.: US 2011/0203330 A1
(43) Pub. Date: Aug. 25, 2011

(54) Method and system for securing luggage

(76) Inventor: Michael Grossman, Marlton, NJ (US)

(21) Appl. No.: 12/712,562

(22) Filed: Feb. 25, 2010

(51) Int. Cl. E05B 65/52; G09F 3/10

(52) U.S. Cl. 70/69; 40/316

(57) ABSTRACT

A disposable, tamper-resistant luggage locking system and method and systems for its use are provided.

### BACKGROUND OF THE INVENTION

The Transportation Security Administration (TSA) screens all checked baggage. As part of the TSA screening, locks may be removed or damaged in transit. If your luggage is secured with a normal luggage lock, which is not recommended by the TSA, airport security will clip the luggage lock.

While necessary for security, forcibly removing luggage locks results in damage to passengers' belongings through clipping of the lock and/or forcibly opening the luggage. This can result in monetary damage to the passengers as well. Further, a new security hazard results since passengers get back luggage with a broken or removed lock which is unsecure and can be subject to tampering or stealing of contents for the rest of the trip.

In addition, the number of claims for theft and damage allegedly caused by the TSA or other airline or government personnel to passengers' luggage has increased.

Combination locks with a master key lock are now available that allow baggage to be screened without breaking the lock or damaging the bag. Instead, the combination locks can be opened by security officers using a universal “master” key so that the locks may not have to be cut. See e.g. U.S. Pat. Nos. 7,021,537 and 7,036,728. Control over access to this “master” key as well as expense of the combinations locks are concerns.

A variety of security tags designed to seal covers or openings of luggage to discourage casual tampering or theft have been described in, for example, U.S. Pat. Nos. 6,343,819; 5,765,885; 5,524,945; 4,470,173; 4,441,233 and 3,712,655 as well as EP patent application 895213.

U.S. Pat. Nos. 6,408,660 and 6,513,349 disclose combined luggage identification and locking systems.

### SUMMARY OF THE INVENTION

The present invention relates to a system and method for securing luggage via a disposable tamper-resistant wire and self-adhesive label. The wire of this luggage locking system is shaped, for example, as a triangle with a split opening along the bottom of the triangle that forms an aperture which, after being threaded through the locking mechanism of the zipper of a piece of luggage, is covered by a self-adhesive, tear-resistant label.

One aspect of the present invention relates to a method for securing luggage comprising threading a wire, shaped for example as a triangle with a split opening along the bottom of the triangle that forms an aperture, through the locking mechanism of the zipper of a piece of luggage and then covering the wire at its aperture with a tear-resistant self-adhesive label so that the wire is secured within the locking mechanism of the zipper and the luggage cannot be opened via its zipper.

Another aspect of the present invention relates to a luggage locking system which comprises a wire, shaped for example as a triangle with a split opening along the bottom of the triangle that forms an aperture, said wire being of a diameter and length which can be threaded through the locking mechanism of a zipper of a piece of luggage; and a tear-resistant self-adhesive label sized to fold-over and cover at least a portion of the wire including its entire aperture by adherence to its self.

Another aspect of the present invention relates to a system for securing luggage and providing notice that luggage has been searched by airport security comprising a first luggage locking system attached to the luggage by a passenger and second luggage locking system attached to the luggage by airport security following removal of the first luggage locking system and searching of the luggage by airport security.

Another aspect of the present invention relates to a system for providing notice to airport security that luggage has been tampered with after checking of the luggage by a passenger. This system comprises a luggage locking system attached to a luggage zipper through its locking mechanism by a passenger and a means for notifying airport security upon checking of the luggage that the luggage locking system was attached upon checking of the luggage.

Another aspect of the present invention relates to an article of manufacture comprising a plurality of these luggage locking systems packaged into a single container.

### BRIEF DESCRIPTION OF THE FIGURES

FIG. 1 is a diagram of a wire of the disposable tamper-resistant luggage locking system of the present invention.

FIG. 2 is a diagram of a tear-resistant self-adhesive label of the system of the present invention.

FIG. 3 is a diagram of the wire with the tear-resistant label self-adhered thereto.

FIG. 4 is a photograph of a suitcase with the disposable tamper-resistant luggage locking system of the present invention threaded through the locking mechanism of the zipper of the suitcase.

### DETAILED DESCRIPTION OF THE INVENTION

The present invention provides a disposable, tamper-resistant luggage locking system and method for its use.

The luggage locking system comprises a wire and self-adhesive label.

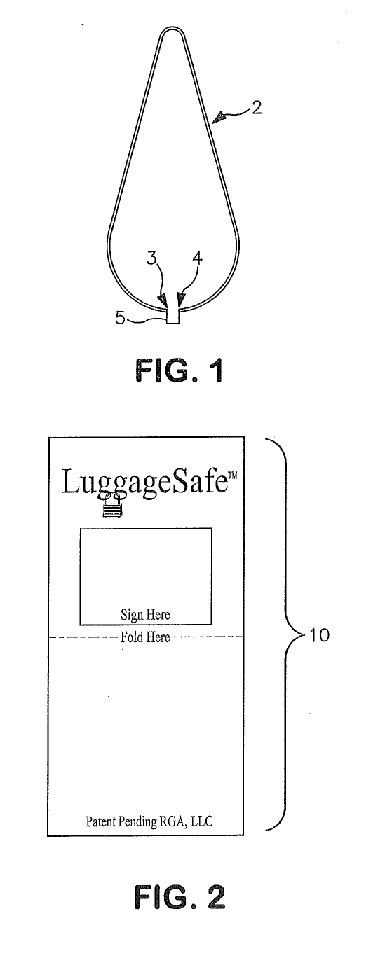

The wire 2 of the luggage locking system comprises a first end 3 and a second end 4 and is configured so that the first end 3 and the second end 4 of the wire 2 meet to form an aperture 5 of a diameter which permits one end of the wire to be easily threaded through a locking mechanism on a zipper of a piece of luggage. FIG. 1 shows one embodiment of the wire 2 in a triangular configuration with the aperture 5 between the first end 3 and second end 4 of the wire along the bottom of the triangle. As will be understood by the skilled artisan upon reading this disclosure, however, alternative wire configurations including, but not limited to, circular, oval, rectangular and square configurations can be used. The wire is comprised of metal or plastic or a combination thereof. The wire has a diameter which can be threaded easily through the locking mechanism of a zipper on a piece of luggage but which provides for sufficient strength so that wire cutters or scissors are required to cut the wire. The length of the wire is variable. In one nonlimiting embodiment, the wire is approximately 6-10 inches in length.

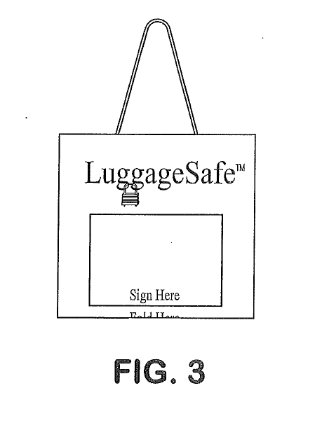

The self-adhesive label 10 of the system is sized and shaped to fold in half over the wire, covering the aperture between the first end and second end of the wire, and adhering to itself, thereby embracing the wire. In one nonlimiting embodiment, as depicted in FIG. 2, the self-adhesive label 10 is rectangular in shape so that upon folding in half over the wire, as depicted in FIG. 3, it forms a square approximately 2 inches in length and width. As will be understood by the skilled artisan upon reading this disclosure, however, alternative configurations of self-adhesive labels can be used. In one embodiment, the self-adhesive label is comprised of a tear-resistant paper or plastic which requires scissors for cutting. In one embodiment, the self-adhesive label comprises a tear-resistant paper or plastic which can be printed on with a printer and/or written on by hand with ink.

Luggage can be secured via the system of the present invention by threading the wire through the locking mechanism of the zipper of a piece of luggage, removing the backing of the self-adhesive label and then folding the self-adhesive label in half over the wire at its aperture so that the label adheres to itself while embracing the wire and securing the wire within the locking mechanism of the zipper.

In one embodiment of the present invention, the passenger signs the label prior to or after attachment of the luggage locking system to the luggage. By signing the label, the passenger renders the luggage locking system of the present invention tamper-resistant as the label is no longer simply replaceable. In this embodiment, the label can be pre-printed with an area for the passenger's signature.

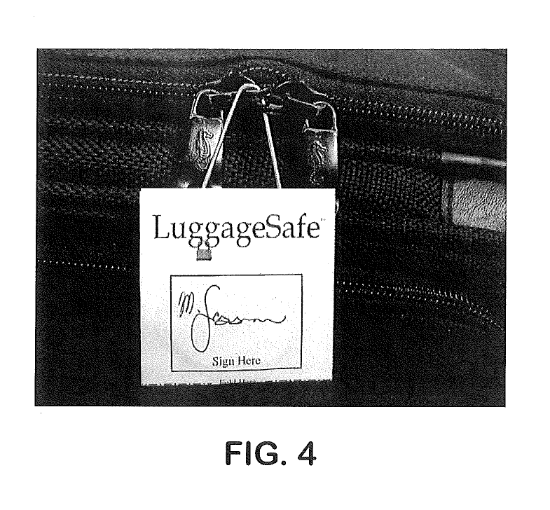

FIG. 4 shows a suitcase with the disposable tamper-resistant luggage locking system of the present invention threaded through the locking mechanism of the zipper of the suitcase.

Upon fixation of the label to the wire at its aperture, to open the luggage via its zipper either the wire must be cut with wire cutters or the label cut with scissors.

This disposable tamper-resistant luggage locking system provides for relatively easy access by airport security to the inside of luggage during searching by simply cutting the wire or label without causing physical damage to the luggage or significant monetary damage to the passenger by destruction of an expensive lock.

In one embodiment of the present invention, the method and system further comprises a second luggage locking system placed on the luggage by airport security after they have removed the first luggage locking system placed on the luggage by the passenger and searched the luggage. In this embodiment, the label of the second luggage locking system is preferably a different color than the label of the first luggage locking system placed on the luggage by the passenger. In one embodiment, the security person inspecting the luggage signs their identification number on the label prior to or after attachment of the second luggage locking system to the luggage. By placing their identification number on the label, the security person provides accountability in the event of issues regarding the search. In this embodiment, the label can be pre-printed with an area for the security person's identification number.

Immediately upon return of the luggage to the passenger notice is provided to the passenger that their wire and label system has been cut and that the inside of their luggage has been searched by airport security either because the luggage locking system has been removed or because a second luggage locking system has been placed on the luggage by airport security. A passenger can then check the contents of their luggage for any damage or theft while still at the airport.

Use of a luggage locking system of the present invention can also be used to provide notice to airport security that luggage may have been tampered with after the passenger has checked the luggage. In this embodiment, upon checking of luggage secured with a disposable, tamper-resistant luggage locking system of the present invention, airport personnel make note of this use via an appropriate means on their computer system, such as, for example, a check box. This in turn would cause a distinguishing mark, for example, but not limited to, an “LS” to be printed at the bottom of the luggage routing tag. Removal of the luggage locking system from luggage with this notification, or the presence of the luggage locking system on luggage without this notification provides notice to airport security that the luggage may have been tampered with at any time during the baggage handling process.

If traveling further, the passenger can easily place another disposable tamper-resistant luggage locking system on their luggage.

Accordingly, a further aspect of the present invention relates to an article of manufacture comprising a plurality of the above-described wires and a plurality of the above-described self-adhesive labels packaged in a single container to provide travelers with an adequate number of disposable, tamper-resistant luggage locking systems for their trip.

What is claimed is:

1. A method for securing luggage with a disposable tamper-resistant luggage locking system, said method comprising:
(a) threading through a locking mechanism on a zipper of a piece of luggage a wire, said wire comprising a first end and a second end and configured so that the first end and the second end of the wire meet to form an aperture of a diameter which permits one end of the wire to be easily threaded through the locking mechanism; and
(b) folding a self-adhesive label over the wire so that the label adheres to itself and covers the aperture between the first end and second end of the wire, thereby embracing the wire so that the wire is secured within the locking mechanism of the zipper and the luggage cannot be opened via its zipper.

2. The method of claim 1 further comprising signing of the self-adhesive label prior to or after adhering the label to the wire.

3. A luggage locking system comprising:
(a) a wire comprising a first end and a second end configured so that the first end and the second end of the wire meet to form an aperture of a diameter which permits one end of the wire to be easily threaded through a locking mechanism of a luggage zipper; and
(b) a self-adhesive label sized to fold over the wire and adhere to itself thereby covering the aperture between the first end and second end of the wire and embracing the wire.

4. The luggage locking system of claim 3 wherein the self-adhesive label is tear-resistant.

5. The luggage locking system of claim 3 wherein the self-adhesive label is pre-printed with a signature area for a passenger to sign prior to or after attachment of the luggage locking system to the luggage.

6. The luggage locking system of claim 3 wherein the self-adhesive label is pre-printed with an area for airport security to write their identification number prior to or after attachment of the luggage locking system to the luggage.

7. The system of claim 3 wherein the wire is metal or plastic.

8. An article of manufacture comprising a plurality of luggage locking systems of claim 3 and a single container for packaging the plurality of luggage locking systems.

9. A system for securing luggage and providing notice that luggage has been searched by airport security, said system comprising:
(a) a first luggage locking system of claim 3 attached to a luggage zipper through its locking mechanism by a passenger;
(b) a second luggage locking system of claim 3 attached to a luggage zipper through its locking mechanism by airport security following removal of the first luggage locking system and searching of the luggage by airport security.

10. The system of claim 9 wherein the label of the second luggage locking system is a different color from the label of the first luggage locking system.

11. A system for providing notice to airport security that luggage has been tampered with after checking of the luggage by a passenger, said system comprising a luggage locking system of claim 3 attached to a luggage zipper through its locking mechanism by a passenger and a means for notifying airport security upon checking of the luggage that said luggage locking system was attached.
